(19) United States
(12) Patent Application Publication
(10) Pub. No.: US 2009/0217706 A1
(43) Pub. Date: Sep. 3, 2009

(54) METHOD FOR PRODUCING COVER GLASS FOR RADIATION-SENSITIVE SENSORS AND DEVICE FOR CARRYING OUT SAID METHOD

(75) Inventors: Andreas Weber, Wiesbaden (DE); Holger Wegener, Alfeld (DE); Reinhard Kassner, Delligsen (DE); Peter Brix, Mainz (DE)

Correspondence Address: BAKER & DANIELS LLP;111 E. WAYNE STREET, SUITE 800, FORT WAYNE, IN, 46802, US

(73) Assignee: Schott AG, Mainz (DE)

(21) Appl. No.: 12/092,369

(22) PCT Filed: Oct. 2, 2006
(86) PCT No.: PCT/EP06/09529

§ 371 Date: Nov. 14, 2008

(30) Foreign Application Priority Data
Nov. 3, 2005 (DE) 10 2005 052 421.4

(51) Int. Cl. C03B 23/023

(52) U.S. Cl. 65/106; 65/286

(57) ABSTRACT

The invention relates to a method for producing a low-radiation cover glass with low intrinsic α-radiation for radiation-sensitive sensors, in particular for use with semiconductor technology, without the production of intermediate moulds, by the direct shaping of plate glass with appropriate dimensions. The invention also relates to a device for carrying out said method.

The invention relates to a method for producing cover glass for radiation-sensitive sensors and a device for carrying out said method.

For specified sensors on semiconductor basis, such as CCD sensors, extraordinarily low-radiation glass is required for packaging. Such a CCD sensor (charge coupled device) is an integrated circuit for light detection which for example is used in digital or video cameras, and constitutes a light-sensitive electronic component for locally resolved (fine screened) measurement of the luminous intensity. CCDs are built out of semiconductors and thus are among the semiconductor detectors.

In the case of such sensors in particular α-radiation is evaluated as particularly critical. The negative effect of radioactive radiation on CCD sensors is for example described in TECHNICAL No. TH-1087 and in JP 04-308669. If for example traces of the radioactive elements uranium and thorium are in a glass, the sensor covered with this glass is massively impaired by its radiation, in particular by its α-rays.

Glass with a low intrinsic α-radiation is known, wherein in the state of the art in particular the impurities of the glass is controlled with uranium and thorium and is brought to the lowest possible level. Thus JP 04-308669 describes for example an image sensor with a color filter which is provided in a package. In this connection a cover glass is mounted in the upper part of the package and lies opposite the sensor. The glass exhibits an overall concentration of uranium and thorium of 30 ppb or less. Further elements cited by JP 04-308669 as undesirable impurities with a negative influence on the sensor are iron and titanium, which together may not exceed an overall concentration of 30 to 100 ppm.

Uranium and thorium emit among other things α-rays, but also β-rays and γ-rays, such as described for example in K. H. Lieser, Einführung in die Kernchemie 1980, S. 4 [Introduction to Nuclear Chemistry 1980, Page 4]. In order to produce a glass with additionally lower intrinsic radiation of β-rays and γ-rays, it was therefore proposed that the glass contain no potassium, since the elements potassium, uranium and thorium occur as known radioactive sources in small to very small quantities in many minerals and stones. For this reason it is advisable to use potassium-free glass, as described for example in the publications JP 2000233939 or JP 2001185710.

Thus JP 2000233939 discloses a cover glass in particular borosilicate glass, whose K2O content is set to <0.2 percentage by mass. The elements emitting α-rays should be present here in general in amounts ≦100 ppb and the quantities in Fe₂O₃, TiO₂, PbO and ZrO₂, which are hard to separate from α-rays, like uranium, thorium and radium, should be present in the glass in amounts ≦100 ppm. The α-rays still emitted by the glass should not exceed a value of 0.05 counts/cm²h.

In similar fashion JP 2001185710 describes a glass made of borosilicate glass which exhibits a uranium content ≦50 ppb and a thorium content ≦50 ppb and which contains essentially no K₂O. The β-radiation is reduced to a value below 5×10⁻⁶ μCi/cm². Also mentioned is the fact that if possible no ZrO₂ or BaO should be contained, in order to prevent an additional load with uranium or thorium, said elements which are frequently present associated with the raw material of these oxides.

As described above, while it is true that there is low-radiation glass with low uranium and thorium content for these applications, in accordance with today's state of the art these have only been available up to now as so-called block glass in the form of bars or cuboids, as is usual for optic glass. Such and its production is described for example in JP 2002-198594, JP 2001-185710 and JP 2000-086281. While it is true that these publications go into the glass composition and melting, it is always tailored to block glass as well as the subsequent expensive further processing steps and it is not taken into consideration that a specified type of a direct shaping would be at all possible.

The cover glass must therefore in accordance with the state of the art always be manufactured out of a block glass by means of numerous steps such as sawing, grinding, polishing. These processes are very expensive in time and material and what is more the producible dimensions and shapes are extraordinarily limited. Thus only relatively small-area substrates with maximum widths of 200 mm can be produced by means of this method. In addition in the case of this method correspondingly by-product accumulates through the sawing and grinding. Additionally defects in the glass (e.g. bubbles, inclusions) can only be determined after completion of the substrate, as a result of which an uneconomical high cull results.

As already explained, it is consequently advantageous to use low-radiation raw materials glass for the production of low-radiation glass. These raw materials stand out by a low uranium and thorium content. In this connection in particular attention is to be paid to a low uranium and thorium content of the silicon dioxide, because this raw material normally has a content of >50 percent by weight or more in the batch.

Further it becomes apparent that it is not sufficient to control only the uranium and thorium content, as is standard in the state of the art. In fact the inventors have been able to prove that a correspondingly low content in uranium and thorium is a necessary but not yet sufficient condition for a glass low in α-radiation. For example, surprisingly it was possible to show that a glass with uranium and thorium content of <10 ppb respectively showed a significantly high α-radiation of 0.2 counts per hour per cm². This radiation is produced by radium, a decomposition product of uranium and thorium. While it is possible to separate radium and thorium by means of geophysical and geochemical operations, radium remains in the base material. This operation can also take place through the chemical treatment at the manufacturer's so that as already described, along with uranium and thorium content preferably also the radium content should be specified and controlled.

In addition the inventors have established that not only do the raw materials that are used for producing a low-radiation glass play a role, but rather also the additional materials used in the production process are of significance. Thus in the present invention also the use of a low-radiation material preferably with low uranium and thorium content and if necessary low radium content is considered for the construction of the melting tank that is used. This is important for the overall tank construction, thus in particular for the melting tank, which is composed of bottom and palisade, optionally also for the tank superstructure, consisting of annular layer and arch. For this purpose up to now in the state of the art no suitable materials have been described.

The material for the tank construction is therefore of importance, because the tank material can partially dissolve in the melting process, and therefore leads to an undesirable impurity through the elements some of which were removed with great expenditure previously from the base materials for the glass composition. Experiments of the applicant show for example that in spite of using raw materials with low uranium and thorium content in the melting in a tank, which for example consisted of aluminum zircon silicate material (as for example ER1681 or ER 1711, Trade Names of SEPR Co., France), a glass with a uranium content of 64 ppb and a thorium content of 97 pbb is obtained. On the other hand if one carries out the melting with the same raw materials in a platinum crucible, one obtains a glass with a uranium content <10 ppb and a thorium content of <10 ppb. This proves that the material used for the tank construction can be very critical for the production of glass with low uranium and thorium content and if necessary low radium content. In addition this shows that the tank material partially dissolves in the glass and with this high impurities of uranium, thorium and radium get into the glass.

In the state of the art in accordance with the Japanese published application JP 2002-198504 for this reason it is proposed to perform the lining of a tank with precious metals. Precious metals like platinum however are too expensive as materials for a large melting tank, which is why these materials cannot be used for the tank construction, in particular for large scale industry.

Further it is known for example from JP 2002249340 that if at all possible no platinum or other precious metal inclusions should be present in the glass, since these can impair the transmission the of the glass and with this the function of the optical sensor. Consequently the materials described in the state of the art are actually unsuitable for the intended application.

The present invention is thus based on the object of avoiding the disadvantages described above of the state of the art and to provide a method for the production of low-radiation glass which has the lowest possible number of steps and requires a significantly lower expenditure than the methods described in the state of the art. In particular no additional steps like sawing, grinding and polishing should be necessary. Further there should be no limitation with regard to the producible dimensions. In spite of this the method should be economical and suitable for large scale production. Finally a suitable device for carrying out the method should be provided.

In accordance with the invention the problem is solved by a method for producing low-radiation cover glass with low intrinsic α-radiation for radiation-sensitive sensors, in particular for use with semiconductor technology, without the production of intermediate molds, by the direct shaping of plate glass with appropriate dimensions. Consequently the glass is not produced in the form of blocks, bars or cuboids, but rather directly as a plane or curved disk. Through the method in accordance with the invention it is therefore possible, in contrast to the already known methods, to produce the glass directly in the desired form and dimension. The production of the products takes place with this independently from the used glass composition, wherein of course low-radiation base materials are used.

The low-radiation cover glass can be produced in accordance with the invention preferably by a drawing method, in particular with a down-draw or an up-draw method, or with a float method. Of course it is clear that the conducting of the method must take place in appropriate manner, after which no foreign components, in particular no rays can get into the glass compositions. This is described in part in very detailed manner in the state of the art and is part of the knowledge of the person skilled in the art.

In the float method one takes advantage of the properties of metals which in a floating state, like any liquid, form a complete smooth surface on the surface through surface tension, wherein glass is only one third as heavy as for example tin, i.e. glass floats on liquid tin. In addition these metals exhibit a melting point which is a great deal lower than the softening point of the glass (e.g. tin: 238° C). If one therefore pours liquid glass on liquid tin, the glass forms a smooth glass surface on its free surface. In the float glass method the liquid glass thus lies on the ideally smooth surface of the liquid tin and solidifies in more perfect surface quality than finished glass, while the tin remains fluid with its much lower melting point.

For the production of flat glass along with the float method drawing methods, for example various down-draw methods like overflow fusion, redraw and jet methods as well as various up-draw methods like Fourcault and Asahi methods can be employed.

In accordance with the down-draw method or up-draw method a glass melt is drawn up or down over a drawing tank with a debiteuse which exhibits a slot as a shaping structural element. The width of the drawing tank determines the drawn glass ribbon width.

In the down-draw or up-draw method the drawing speeds employed lie preferably in the range of 0.1 to 15 m/min, but can also significantly exceed or fall below said range in a given case. In accordance with the invention the use of the down-draw method is very especially preferred.

Advantageously low-radiation cover glass can be produced with the described methods in a thickness of 0.03 to 20 mm, in particular of 0.1 to 5 mm. Reference is made for example to DE 101 28 636 C1 for the influencing of the glass thickness in the production of plate glass. Improvements for the down-draw method, in particular the setting of a desired thickness constancy and planarity even in the case of thin glass sheets are for example known from DE 10 2004 007 560 A1. The disclosure content of both documents is to be completely included here.

Through the method in accordance with the invention via a direct shaping of the cover glass the glass is thus successfully obtained directly in the desired thickness as a plate glass. Through the dropping of intermediate steps, as these are normally present in the state of the art, the method becomes distinctly simplified, the costs lowered, the cull reduced to a minimum and with this the economic efficiency is increased to a high degree, which means quite considerably advantages in large-scale industry.

The method in accordance with the invention also contributes to the high quality requirements in glass being able to be fulfilled. The quality of the produced glass is determined namely along with the actual glass composition in particular through the shaping method, wherein in accordance with the invention not only bubbles and inclusions are prevented, but rather also direct influence is made on the surface quality, like the low corrugation of the surface and a slight deviation of the surface from the flatness.

In addition with the method of the invention—unlike the state of the art—large-area substrates can be produced, whose dimensions are clearly above the dimensions possible in the state of the art, for example 200 mm×200 mm.

Preferably materials with low intrinsic α-radiation are used as base materials for the glass. The terms “low-radiation” or “with low intrinsic radiation” should be understood within the scope of the present invention in such a way that the se materials only emit α-radiation in an extent that a sensor located in immediate proximity will not be negatively influence by it. Regarding the α-radiation among others in JP 2004238283 a radiation intensity of <0.0015 counts/cm²×h is required in order to describe a glass with sufficiently low α-radiation. This value is simultaneously the detection limit of the 2 measuring instrument used there (LACOM-4000, detector surface 4000 cm², Manufacturer: Sumimoto).

The base materials (glass compositions) for the glass can in accordance with the invention be selected in such a way that the uranium, thorium and optionally radium content of the produced glass is selected in such a way that the desired low intrinsic α-radiation is obtained. In accordance with the invention it was surprisingly established that in the state of the art, such as for example JP 2002-198504, JP 2000-086281, or JP 2004-238283 the named upper limit of a uranium and thorium content of 5 ppb each can be exceeded without the expected serious negative impact on the α-radiation. A lower limit preferably of 20 ppb or less, in particular 15 ppb or less, quite especially preferably 10 ppb or less, for the uranium and thorium content respectively, preferably also for the radium content, is definitely sufficient for the desired applications. Without limiting it to this, it is assumed that the reason for this lies in the fact that the α-radiation in glass with a density of e.g. 2.51 g/cm3 has a range of circa 20 μm. That is, only the α-rays in the glass which are present in the first 20 μm of the surface contribute to the α-radiation on the sensor surface.

The low-radiation cover glass, which is used in the method in accordance with the invention, exhibits thus advantageously a uranium, thorium and if necessary radium content in the amount that the α-radiation exhibits a radiation intensity of <0.0020 counts/cm2×h, preferably a radiation intensity of <0.0015 counts/cm2×h, especially preferably a radiation intensity of <0.0013 counts/cm2×h. In individual cases a radiation intensity of <0.0010 counts/cm2×h can also be set. This is, as already explained, in surprising manner preferably already achieved in the case of a uranium, thorium and if necessary also radium content of <20 ppb respectively, preferentially with a content of <15 ppb respectively, especially preferentially with a content of <10 ppb respectively.

The glass compositions for the low-radiation cover glass used in accordance with the invention are within the scope of the invention otherwise not especially restricted, provided said compositions have the makings for a low intrinsic radiation. Suitable in particular as low-radiation cover glass with low intrinsic α-radiation are glass compositions which are selected from aluminosilicate glass, aluminoborosilicate glass, borosilicate glass, in particular alkali-free borosilicate glass, or soda lime silicate glass. Preferably used are for example float glass, such as e.g. borosilicate glass (e.g. D 263, Borofloat 33, Borofloat 40, BK 7, Duran from Schott A G, Mainz, Germany) as well as alkali-free glass (e.g. AF 37, AF 45 from Schott A G, Mainz, Germany), aluminosilicate glass (e.g. Fiolax, Illax from Schott A G, Mainz, Germany), alkaline earth glass (e.g. B 270 from Schott A G, Mainz, Germany), Li₂O—AI₂O₃—SiO₂ float glass or discolored float glass with an iron concentration below 100 ppb.

The following are named as exemplary glass compositions that can be processed with the method in accordance with the invention (percent by weight on an oxide base):

| | | |
|---|---|---|
| SiO₂ | 60-70 | Percent by weight |
| Na₂O | 1-10 | Percent by weight |
| K₂O | 0-20 | Percent by weight |
| ZnO | 0-10 | Percent by weight |
| AI₂O₃ | 0-10 | Percent by weight |
| B₂O₃ | 0-10 | Percent by weight |
| TiO₂ | >0.1-10 | Percent by weight, in particular 1-8 |
| | | percent by weight, very especially |
| | | preferred 4 percent by weight |
| Sb₂O₃ | 0-2 | Percent by weight |

Further applicable glass compositions can be selected from one of the following compositions (percent by weight on an oxide base):

| | | |
|---|---|---|
| SiO₂ | 48-58 | Percent by weight |
| BaO | 10-30 | Percent by weight |
| B₂O₃ | 1-15 | Percent by weight |
| AI₂O₃ | 0-20 | Percent by weight |
| As₂O₃ | 0-5 | Percent by weight |
| SrO | 0-3 | Percent by weight |
| CaO | 0-5 | Percent by weight |

wherein optionally 1 to 2 percent by weight of the BaO can be replaced with TiO₂.

In the case of the use of BaO in one of the glass compositions particular attention is to be paid to ensure that no radium content barium is used, as a result of which the portion of the α-radiation would significantly increase.

Further glass compositions are selected from one of the following compositions (percent by weight on an oxide base):

| | | |
|---|---|---|
| SiO₂ | 45-70 | Percent by weight |
| B₂O₃ | 1-20 | Percent by weight |
| AI₂O₃ | 0-20 | Percent by weight |
| Na₂O | 1-10 | Percent by weight |
| BaO | 1-10 | Percent by weight |
| ZnO | 1-5 | Percent by weight |
| As₂O₃ | 0-2 | Percent by weight |
| TiO₂ | 1-5 | Percent by weight |

The invention also relates to a device for carrying out the method in accordance with the invention, wherein the above descriptions for the method are equally applicable to the device.

In accordance with the invention it is additionally of advantage when in the method in accordance with the invention or of the device in accordance with the invention materials with low intrinsic α-radiation are used as materials in or with which the glass is produced, such as the tank materials, in particular the melting tank. In order to avoid the use of precious metal, such as platinum, as contact material for the melting of the raw materials or as material for lining the inside of the tank, for this reason preferably a tank material with a low uranium and thorium content is used, in particular a material with a uranium and thorium content and optionally a radium content of <100 ppb respectively. Advantageously especially in the region of the melting tank precious metal materials are dispensed with completely. The melted raw materials in the melting region are very corrosive, so that reactions of the aggressive melting with precious metals are suppressed. Lining the melting tank with precious metal is also out of the question in the method in accordance with the invention for technical reasons, since the electric heating as a rule takes place with the help of electrodes which are dipped into the melt, so that a lining with precious metal would prevent the flow of the current through the melt.

However, dispensing with precious metals in the region of the melting tank does not mean that precious metals must be dispensed with in another place in the method or the device, since as a rule the melt reacts so aggressively only in the region of the melting tank that it is sufficient to exclude precious metals there.

The tank blocks used in accordance with the invention are accordingly produced preferably in such a way that they exhibit a low intrinsic α-radiation. Thus there are possibilities for producing the tank blocks from low-radiation base materials.

In order to provide the purest possible material for the melting tank, in particular the melting tank, for example high purity amorphous silicon dioxide is preferably used as a base material. For example after the slip casting method then the tank blocks are manufactured out of this high purity amorphous silicon dioxide, said tank blocks preferably exhibiting a uranium and thorium content of <100 ppb respectively, even more preferably <80 ppb, especially preferably <50 ppb. In particular also the radium content is preferably set to <100 ppb, even more preferably to <80 ppb, especially preferably to 50 ppb.

Additionally preferably a particularly low-radiation material can be used as mold material in which the tank blocks are poured, such as for example plaster which has been tested for low intrinsic α-radiation. In addition to the use of low-radiation base materials and/or low-radiation mold materials low-radiation tank blocks can be obtained in particular as a result of the fact that said tank blocks are subjected to an additional surface treatment after their production. After production of the tank blocks for example by pouring into a mold the surface, in particular the top layer of the tank blocks, is then preferably removed at all later contact areas with the glass melt, for example by means of appropriate surface removal, such as cutting and/or grinding. This can for example mean a removal of the surface by some mm, such as about 3 to 5 mm.

The described variants for the production of low-radiation tank blocks can be correspondingly combined in order to obtain optimum results.

Studies have shown that for example in the case of a melt of the specified glass compositions of the SCHOTT AG up to a maximum of 3 percent by weight of the tank material can be contained in the glass. In order to melt a glass with the least possible uranium, thorium and optionally radium content for example of about 15 ppb, for this reason preferably also no refuse glass should be used for this melt, since said refuse glass then lead to an undesired increase of the uranium, thorium and if necessary radium content.

The LAICPM method (Laser Ablation Inductive Coupled Plasma Mass Spectrometry) is used for testing and checking of the raw materials, of the tank material and of the glass for content in uranium, thorium and radium. This method allows the determination of uranium, thorium and radium with a detection limit of 2 ppb.

It is also particularly advantageous when the portion of the elements of the rare earths is as low as possible. Thus it is advantageous when the following elements are present in the specified maximum quantities or below:

Neodymium 0.5 ppm, preferably 0.2-0.4

Gadolinium 0.5 ppm, preferably 0.1 ppm

Hafnium 0.5 ppm, preferably 0.3-0.4 ppm,

Samarium 0.1 ppm.

Further it has proved to be advantageous when the melt, after leaving the specially lined tank which as described above contains particularly low-radiation material or consists thereof, is transported via special conduits for further processing, the material of said conduits also exhibiting a very low intrinsic α-radiation. Suitable in particular for this purpose is precious metal like platinum, iridium or rhodium or an alloy thereof, for example Ptir1 or PtRh10.

The advantages of the present invention are extraordinarily diverse.

By means of the selection of a specified production process, such as for example a drawing method, in particular a down-draw method or an up-draw method, or a float method, it can be managed to get to low-radiation glass which is suitable for use in radiation-sensitive sensors. Regardless of the glass composition that is used the method of the invention for the production of low-radiation cover glass in the form of plate glass under direct shaping offers the advantages that intermediate steps are dropped, dimensions are accessible which up to now have not been producible and in spite of this glass can be produced with the required quality features. Further by means of the omission of expensive production steps like cutting, grinding, polishing the cull is reduced to a minimum. Defects in the glass (e.g. bubbles, inclusions), which could only be ascertained in the case of the known methods after finishing, can be avoided with the conducting of the method in accordance with the invention. The economic efficiency is significantly increased through the above advantages, in particular in the case of use on large industrial scale. By means of the method in accordance with the invention via a direct shaping of the cover glass it is thus managed to obtain the glass directly in the desired thickness as plate glass.

In addition to glass base materials with low intrinsic radiation in the method in accordance with the invention for the melt tank preferably used, in particular the melting tank which is composed of bottom and palisade, optionally also for the tank superstructure, composed of annular layer and arch, low-radiation materials are used. In particular in the region of the melt tank in accordance with the invention however the use of precious metals, like platinum, is dispensed with, in order to exclude precious metal inclusions in the glass, which could impair the transmission of the glass and with it the function of the optical sensor. Advantageously in the process precious metal materials are completely dispensed with only in the region of the melt tank, since the raw materials in the melting region react very corrosively and aggressively and a heating of the melt with electrodes in the case of the use of a precious metal lining would not be possible. However, precious metals can be used in advantageous manner as materials for the conduits for further transportation of the glass melt out of the melt tank for further processing.

In accordance with the invention, preferably a low-radiation base material is used as a base material for the tank blocks, especially preferably high purity amorphous silicon dioxide, with a uranium, thorium and optionally radium content preferably of <100 ppb respectively, especially preferably <80 ppb, very especially preferably <50 ppb. A low intrinsic α-radiation of the tank blocks can be guaranteed already in the production of the tank blocks by means of the use of low-radiation base materials and/or low-radiation mold materials and/or surface removal of the contact areas with the latter glass melt.

The subsequent exemplary embodiments serve the purpose of the illustration of the teaching in accordance with the invention. They are only to be understood as possible, exemplary represented approaches without limiting the invention to their contents.

### EXEMPLARY EMBODIMENTS

Subsequently the invention will be described with the assistance of exemplary embodiments.

With the down-draw method in accordance with the invention low-radiation glass with the following composition was produced in a device provided with a low-radiation melt tank, wherein the width of the plate glass produced was 430 mm respectively. The thickness of the glass ranged between 0.3-0.8 mm.

Glass Composition I:

| | | |
|---|---|---|
| SiO₂ | 64.8 | Percent by weight |
| Na₂O | 6.25 | Percent by weight |
| K₂O | 6.7 | Percent by weight |
| ZnO | 5.6 | Percent by weight |
| AI₂O₃ | 4.2 | Percent by weight |
| B₂O₃ | 7.9 | Percent by weight |
| TiO₂ | 4.0 | Percent by weight |
| Sb₂O₃ | 0.55 | Percent by weight |
| Total | 100 | Percent by weight |

Glass Composition II:

| | | |
|---|---|---|
| SiO₂ | 50.3 | Percent by weight |
| BaO | 24.7 | Percent by weight |
| B₂O₃ | 12.6 | Percent by weight |
| AI₂O₃ | 11.3 | Percent by weight |
| As₂O₃ | 0.7 | Percent by weight |
| SrO | 0.3 | Percent by weight |
| CaO | 0.1 | Percent by weight |
| Total | 100 | Percent by weight |

Glass Composition III:

| | | |
|---|---|---|
| SiO₂ | 50.3 | Percent by weight |
| BaO | 20 | Percent by weight |
| B₂O₃ | 12.7 | Percent by weight |
| TiO₂ | 4.7 | Percent by weight |
| AI₂O₃ | 11.3 | Percent by weight |
| As₂O₃ | 0.7 | Percent by weight |
| SrO | 0.20 | Percent by weight |
| CaO | 0.1 | Percent by weight |
| Total | 100 | Percent by weight |

The cover glass produced in accordance with the invention was low-radiation, wherein the uranium, thorium and radium content were around 100 ppb respectively. In spite of this the measured α-radiation had a radiation intensity of <0.0013 counts/cm²h, so that the glass is suitable for radiation-sensitive sensors.

1. A method for producing a low-radiation glass cover with low intrinsic α-radiation for low-radiation sensors, in particular for use with semiconductor technology, without the production of intermediate molds, by the direct shaping of plate glass, wherein the base materials for the low-radiation cover glass exhibit a uranium, thorium and radium content of <20 ppb respectively characterized in that for the production of the low-radiation cover glass a melt tank, in particular a melt tank composed of bottom and palisade, optionally a tank superstructure composed of annular layer and arch are used which contain or consist of a low-radiation material, in particular a material with a uranium, thorium and radium content of <100 ppb, preferably <80 ppb, very especially preferably <50 ppb.

2. Method according to claim 1, characterized in that the low-radiation cover glass is produced by a drawing method, in particular with a down-draw or an up-draw method, or a float method.

3. The method according to claim 1, characterized in that the low-radiation cover glass is produced in a thickness ranging from 0.03 to 20 mm, in particular 0.1 to 5 mm.

4. The method according to claim 1, characterized in that the low-radiation cover glass is produced in a down-draw or up-draw method with a drawing speed of 0.1 to 15 m/min, in particular of 0.4 to 8 m/min.

5. The method according to claim 1, characterized in that the low-radiation cover glass is produced as large-area substrates whose width and/or length are over 200 mm.

6. The method according to claim 1, characterized in that the materials for the glass are selected in such a way that the uranium and thorium content of the glass produced therefrom is <15 ppb respectively, especially preferably <10 ppb respectively.

7. The method according to claim 1, characterized in that the materials for the glass are selected in such a way that the radium content of the glass produced therefrom is <15 ppb, especially preferably <10 ppb.

8. The method according to claim 1, characterized in that no refuse glass is used for the melt.

9. The method according to claim 1, characterized in that for the production of the low-radiation cover glass tank blocks are used which contain or consist of a low-radiation material, in particular a material with a uranium and thorium content of <100 ppb respectively, preferably <80 ppb, very especially preferably <50 ppb.

10. The method according to claim 1, characterized in that for the production of the low-radiation cover glass tank blocks are used which contain or consist of a low-radiation material, in particular a material with a radium content of <100 ppb, preferably <80 ppb, very especially preferably <50 ppb.

11. The method according to claim 9, characterized in that the low-radiation tank blocks are manufactured from low-radiation base materials in the slip casting method.

12. The method according to claim 11, characterized in that the low-radiation tank blocks are manufactured using a low-radiation mold material.

13. The method according to claim 11, characterized in that the low-radiation tank blocks are subjected to a surface treatment after production in the slip casting method.

14. The method according to claim 13, characterized in that the surface treatment is carried out in the form of a removal of the surfaces coming into contact with the melt in the melt tank, in particular the top surface layer.

15. The method according to claim 14, characterized in that the removal of the surface, in particular of the top surface layer is carried out by means of grinding or cutting.

16. The method according to claim 1, characterized in that the melt tank is lined with tank blocks which contain or consist of high purity amorphous silicon dioxide with a uranium and thorium and radium content of <100 ppb respectively, preferably <80 ppb, very especially preferably <50 ppb.

17. The method according to claim 1, characterized in that a glass composition selected from one of the subsequent compositions (percent by weight on an oxide base) is used:

| | | |
|---|---|---|
| SiO₂ | 60-70 | Percent by weight |
| Na₂O | 1-10 | Percent by weight |
| K₂O | 0-20 | Percent by weight |
| ZnO | 0-10 | Percent by weight |
| AI₂O₃ | 0-10 | Percent by weight |
| B₂O₃ | 0-10 | Percent by weight |
| TiO₂ | >0.1-10 | Percent by weight, in particular |
| | | 1-8 percent by weight, |
| Sb₂O₃ | 0-2 | Percent by weight |

18. The method according to claim 1, characterized in that a glass composition selected from one of the subsequent compositions (percent by weight on an oxide base) is used:

| | | |
|---|---|---|
| SiO₂ | 48-58 | Percent by weight |
| BaO | 10-30 | Percent by weight |
| B₂O₃ | 1-15 | Percent by weight |
| AI₂O₃ | 0-20 | Percent by weight |
| As₂O₃ | 0-2 | Percent by weight |
| SrO | 0-3 | Percent by weight |
| CaO | 0-5 | Percent by weight |
| optionally TiO₂ | 0.1-10 | percent by weight, in particular |
| | | 1-8 percent by weight. |

19. The method according to claim 1, characterized in that a glass composition selected from one of the subsequent compositions (percent by weight on an oxide base) is used:

| | | |
|---|---|---|
| SiO₂ | 45-70 | Percent by weight, in particular |
| | | 60-70 percent by weight, |
| B₂O₃ | 1-20 | Percent by weight, in particular |
| | | 10-15 percent by weight, |
| AI₂O₃ | 0-20 | Percent by weight, in particular |
| | | 5-10 percent by weight, |
| Na₂O | 1-10 | Percent by weight, in particular |
| | | 1-10 percent by weight, |
| BaO | 1-10 | Percent by weight, in particular |
| | | 5-10 percent by weight, |
| ZnO | 1-5 | Percent by weight, in particular |
| | | 1-2 percent by weight, |
| As₂O₃ | 0-2 | Percent by weight, in particular |
| | | 0.1-1 percent by weight, |
| TiO₂ | 1-5 | Percent by weight, in particular |
| | | 1-2 percent by weight. |

20. A device for the carrying out of the method according to claim 1, comprising a melt tank, in particular a melt tank composed of bottom and palisade, optionally a tank superstructure, composed of annular layer and arch, for production of the low-radiation cover glass, characterized in that the melt tank optional palisades and arch contain a low-radiation material or consist thereof, in particular a material with a uranium and thorium content of <100 ppb respectively, preferably <80 ppb, very especially preferably <50 ppb.

21. The device according to claim 20, characterized in that the melt tank is lined with low-radiation tank blocks which contain or consist of a low-radiation material, in particular a material with a uranium and thorium content of <100 ppb respectively, preferably <80 ppb, very especially preferably <50 ppb.

22. The device according to claim 20, characterized in that the melt tank is lined with low-radiation tank blocks which contain or consist of a low-radiation material, in particular a material with a radium content of <100 ppb, preferably <80 ppb, very especially preferably <50 ppb.

23. The device according to claim 21, characterized in that the melt tank is lined with low-radiation tank blocks which contain or consist of high purity amorphous silicon dioxide with a uranium, thorium and radium content of <100 ppb respectively, preferably <80 ppb, especially preferably <50 ppb.
